(19) United States
(12) Patent Application Publication
(10) Pub. No.: US 2004/0109576 A1
(43) Pub. Date: Jun. 10, 2004

(54) MULTI-CHANNEL EARPHONE MODULE

(76) Inventors: HSAING-HUEI YOU, TAIPEI (TW); JUNG-CHIN CHANG, TAIPEI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,571

(22) Filed: Apr. 21, 2003

(30) Foreign Application Priority Data
Dec. 6, 2002 (TW) 91219790

(51) Int. Cl. H04R 25/00; H04R 5/02; H04R 1/02; H04R 9/06

(52) U.S. Cl. 381/309; 381/335; 381/182

(57) ABSTRACT

A multi-channel earphone module is provided. The earphone module comprises two earphone units for engaging with each respective ear of a user. Each earphone unit includes a housing, a front channel speaker, a rear channel speaker and a subwoofer channel speaker. The front and the back channel speaker are adjacent to each other within the housing. The subwoofer channel speaker is installed at the bottom of the housing. The axis of the front channel speaker and the axis of the rear channel speaker form an acute angle for reducing the overlapping or interference of acoustic sound waves and improving output sound quality.

### CROSS REFERENCE TO RELATED APPLICATIONS

This application claims the priority benefit of Taiwan application serial no.91219790, filed on Dec. 6, 2002.

### BACKGROUND OF INVENTION

1. Field of Invention

The present invention relates to an earphone module. More particularly, the present invention relates to a multi-channel earphone module with multi-channel sound output.

2. Description of Related Art

With the great advance in the electronics industry, all types of electronic products have begun to be specially designed to occupy as little space and be as portable as possible. For sound-producing devices such as earphones, this trend is obvious. An earphone is normally strapped onto the head of a user. In general, the type of mounting includes a headset earplug earphone and earflap earphone.

For music lovers or movie goers, on-site sound quality is of the utmost importance. To simulate the sound of a real scene, big loudspeakers are normally positioned around the user. Using a 5.1 channel sound output as an example, a front/left channel speaker, a front/right channel speaker, a rear/left channel speaker, a center channel speaker and a subwoofer channel speaker are the essential sound parts. All these speakers are spread out around the user so that acoustic delay is relied on creating on-site sound effects.

However, when a user is listening to music outdoors or happens to be in a confined area watching a movie, the aforementioned special setup of speakers for obtaining superior on-site sound quality is impossible. Under such circumstance, researchers have developed a type of multi-channel earphone module capable of simulating the sound effects of large sound systems. Unlike a complete sound system, the multi-channel earphone module is light and compact and hence easy to carry around.

FIG. 1 is a perspective view of a conventional multi-channel earphone module. The multi-channel earphone module 100 includes a bridge element 110 and two earphones 120. The two earphones 120 are connected together to form a headgear through the bridge element 110. Thus, the two earphones 120 are positioned over each respective ear when the earphone module 100 is worn on the head of a user.

FIG. 2A is a schematic cross-sectional view showing the elements inside a conventional earphone unit. A conventional earphone unit 200 (the earphone 120 in FIG. 1) mainly includes a housing 210, a front channel speaker 220, a front channel sound box 222, a rear channel speaker 230, a rear channel sound box 232 and a subwoofer channel speaker 240. The front channel sound box 222 enclosing the front channel speaker 220 is set up inside the housing 210. The rear channel sound box 232 enclosing the rear channel speaker 230 is also set up inside the housing 210 next to the front channel sound box 222. The subwoofer channel speaker 240 is attached to the bottom section inside the housing 210.

FIG. 2B is a schematic cross-sectional view showing relative positions of the front channel speaker, the rear channel speaker and the subwoofer channel speaker inside the earphone unit in FIG. 2. For a conventional earphone unit 200, the central axis of the front channel speaker 220 is parallel to the central axis of the rear channel speaker 230. With this set up, sound produced by the front channel speaker 220 will seriously overlap and interfere with sound produced by the rear channel speaker 230. In other words, quality of output sound will likely deteriorate and the degree of detachment between sound coming from the front channel and the rear channel will likely be minimized.

FIG. 2C is a schematic cross-sectional view of the front channel sound box shown in FIG. 2A. As shown in FIG. 2C, the bottom wall inside the front channel sound box 222 has a planar surface 222a. Hence, acoustic waves produced by the front channel speaker 220 can easily bounce back up from the planar surface 222a towards the front end of the front channel sound box 222 and overlap or interfere with normal sound waves there to produce some undesirable noise.

### SUMMARY OF INVENTION

Accordingly, one object of the present invention is to provide a multi-channel earphone module that can reduce acoustic overlapping or interference inside an earphone unit and improve output sound quality.

To achieve these and other advantages and in accordance with the purpose of the invention, as embodied and broadly described herein, the invention provides a multi-channel earphone module. The multi-channel earphone module at least includes a pair of earphone units for covering over each respective ear of a user. Each earphone unit includes a housing, a front channel speaker, a rear channel speaker and a subwoofer channel speaker. The front channel speaker and the rear channel speaker are set up next to each other inside the housing. The central axis of the front channel speaker and the central axis of the rear channel speaker form a first acute angle. The subwoofer channel speaker is mounted on the bottom portion of the housing.

According to the multi-channel earphone module of this invention, the first acute angle is between 25°˜35°, and preferably at 30°.

According to the multi-channel earphone module of this invention, the central axis of the front channel speaker and the central axis of the subwoofer channel speaker form a second acute angle. The second acute angle ranges between 5°˜15°, preferably at 10°. Furthermore, the central axis of the rear channel speaker and the central axis of the subwoofer channel speaker form a third acute angle. The third acute angle ranges between 15°˜25°, preferably at 20°.

According to the multi-channel earphone module of this invention, each earphone unit further includes a front channel sound box, a rear channel sound box and a subwoofer channel sound box. The front channel sound box encloses the front channel speaker and the rear channel sound box encloses the rear channel speaker. Both the front channel sound box and the rear channel sound box are enclosed inside the housing next to each other. The subwoofer channel sound box encloses the subwoofer channel speaker. The subwoofer channel sound box is attached to the bottom section of the housing.

According to the multi-channel earphone module of this invention, the interior wall at the bottom section of the front channel sound box has a wavy surface. Furthermore, the front channel sound box has at least a venting hole at its bottom section. The wavy surface has a wave profile similar to an outward radiating wave pattern that corresponds to the axial direction of the front channel speaker.

According to the multi-channel earphone module of this invention, the ratio of diameters in the axial direction between the front channel speaker, the rear channel speaker and the subwoofer channel speaker is (30.5): (28.5): (40.5), but preferably the ratio is 30:28:40.

According to the multi-channel earphone module of this invention, the acoustic signals picked up by the front channel speaker and the rear channel speaker is 180° out of phase with the acoustic signals picked up by the subwoofer channel speaker.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a perspective view of a conventional multi-channel earphone module;

FIG. 2A is a schematic cross-sectional view showing the elements inside a conventional earphone unit;

FIG. 2B is a schematic cross-sectional view showing relative positions of the front channel speaker, the rear channel speaker and the subwoofer channel speaker inside the earphone unit in FIG. 2A;

FIG. 2C is a schematic cross-sectional view of the front channel sound box shown in FIG. 2A;

FIG. 3 is a perspective view of a multi-channel earphone module according to one preferred embodiment of this invention;

FIG. 4A is a schematic cross-sectional view showing the elements inside an earphone unit according to one preferred embodiment of this invention;

FIG. 4B is a schematic cross-sectional view showing relative positions of the front channel speaker, the rear channel speaker and the subwoofer channel speaker inside the earphone unit in FIG. 4A;

FIG. 4C is a schematic cross-sectional view of the front channel sound box shown in FIG. 4A; and

FIG. 5 is a graph showing the difference in frequency response between a front/rear channel sound box with and without a wavy interior surface at its bottom wall.

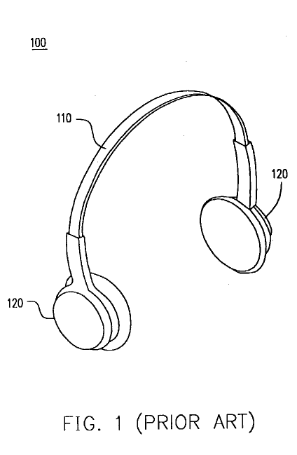

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

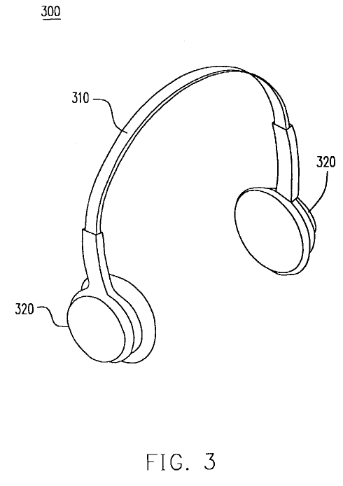

FIG. 3 is a perspective view of a multi-channel earphone module according to one preferred embodiment of this invention. As shown in FIG. 3, the multi-channel earphone module 300 includes a bridge element 310 and two earphones 320. The two earphones 320 are connected together to form a headgear through the bridge element 310. Thus, the two earphones 320 snuggly fit over each respective ear of a user when the earphone module 300 is worn on the head of the user. Note that the bridge element 310 can be a wearable artifact including a head collar, an ear hanger, a neck collar, a helmet or a cap.

To simulate actual field sound including left/right and front/rear movement of sound sources, the multi-channel earphone module 300 must at least provide a four channel sound output. In other words, at least two channels of sound should be transmitted to each user“s ear and that the sound sources must be designed with a front/rear positioning arranged. In addition, to simulate the low frequency portion (the heavy bass portion) of a sound source, the multi-channel earphone module 300 must also include a subwoofer channel on each side. To simplify the explanation of the working of the multi-channel earphone module 300, only one of the earphone units 320 (the left side or the right side) is shown in the following.

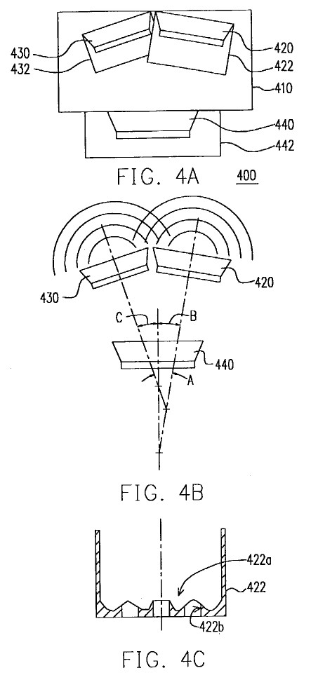

FIG. 4A is a schematic cross-sectional view showing the elements inside an earphone unit according to one preferred embodiment of this invention. The earphone unit 400 (the earphone unit 320 in FIG. 3) mainly comprises a housing 410, a front channel speaker 420, a front channel sound box 422, a rear channel speaker 430, a rear channel sound box 432, a subwoofer channel speaker 440 and a subwoofer channel sound box 442. The front channel sound box 422 encloses the front channel speaker 420 and the rear channel sound box 432 encloses the rear channel speaker 430. The housing 410 encloses both the front channel sound box 422 and the rear channel sound box 432. The subwoofer channel speaker 440 is attached to the bottom section of the housing 410. Note that the earphone unit 400 of this invention has an extra subwoofer channel sound box 442 at the bottom of the housing 410 for enclosing the subwoofer channel speaker 440. Thus, each speaker inside the earphone unit 400 has an associated sound box. The housing 410 also serve as a common sound box for both the front channel speaker 420 and the rear channel speaker 430. In addition, the back of the front channel sound box 422, the rear channel sound box 432 and the subwoofer channel sound box 442 all have backside air vents. In other words, the bottom section of all the sound boxes has venting holes (not shown) for relieving acoustic pressure.

FIG. 4B is a schematic cross-sectional view showing relative positions of the front channel speaker, the rear channel speaker and the subwoofer channel speaker inside the earphone unit in FIG. 4A. As shown in FIG. 4B, the central axis of the front channel speaker 420 and the central axis of the rear channel speaker 430 form a first acute angle A between 25°˜35° but preferable at 30°. In fact, the angular placement between the front channel speaker 420 and the rear channel speaker 430 is equivalent to the central axis of the front channel speaker 420 making a second acute angle B of between 5°˜15° but preferably 10° with the central axis of the subwoofer channel speaker 440 and the central axis of the rear channel speaker 430 making a third acute angle C of between 15°˜25° but preferably 20° with the central axis of the subwoofer channel speaker 440. According to the aforementioned angular settings, overlap or interference of sound waves between the front channel speaker 420 and the rear channel speaker 430 is greatly reduced. Hence, sound quality of the earphone module is improved while the degree of front/rear channel detachment is increased.

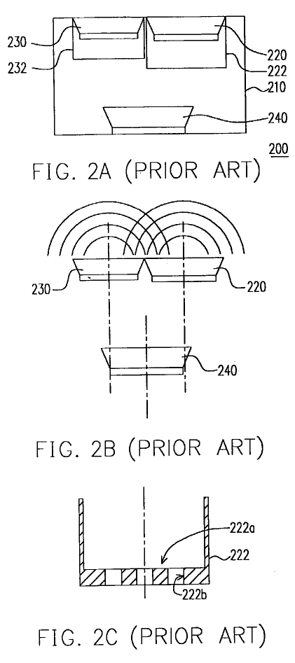

FIG. 4C is a schematic cross-sectional view of the front channel sound box shown in FIG. 4A. As shown in FIG. 4C, the interior wall at the bottom of the front channel sound box 422 has a wavy surface 422a. Furthermore, the wave pattern on the wavy surface 422a may correspond with an outward radiating wave in the axial direction of the front channel speaker 420 shown in FIG. 4B. Therefore, sound waves produced by the front channel speaker 420 may leak out through air vents 422b at the bottom wall of the front channel sound box 422 into the housing (the common sound box) 410 shown in FIG. 4A. Unlike the conventional front channel sound box 222 in FIG. 2C, the front channel sound box 422 in this invention is able to lower acoustic overlap and interference considerably so that the overall noise level is reduced. Similarly, the rear channel sound box 432 shown in FIG. 4A can have the same type of wall structure too.

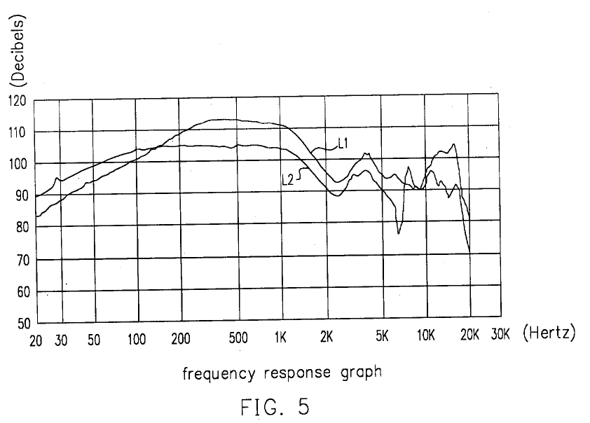

FIG. 5 is a graph showing the difference in frequency response between a front/rear channel sound box with and without a wavy interior surface at its bottom wall. Curve L1 corresponds to the frequency response for a front/rear sound box without a wavy bottom wall surface. Variation of curve L1 within the frequency range 100 Hz˜1 kHz is considerable and the acoustic strength exceeds 110 dB. In other words, a conventional multi-channel earphone module may incorporate sizzling or whistling noise. On the other hand, curve L2 corresponds to the frequency response for a front/rear sound box after the introduction of a wavy surface onto its bottom wall surface. Variation of curve L2 within the frequency range 100 Hz˜1 kHz is milder and the acoustic strength at the most sensitive frequency 1 kHz for a human ear does not excess 105 dB. Hence, the multi-channel earphone module of this invention produces less sizzling or whistling sound within this frequency range and overall quality of sound is improved.

To improve the output quality of sound in the earphone unit 400 in FIG. 4A even further, the ratio of diameters in the axial direction between the front channel speaker, the rear channel speaker and the subwoofer channel speaker is (300.5): (280.5): (400.5), but preferably the ratio is 30:28:40. In addition, the front channel speaker 440 and the rear channel speaker 430 as a unit is driven out of phase with the subwoofer channel speaker 440. In other words, the acoustic signals picked up by the front channel speaker and the rear channel speaker is 180° out of phase with the acoustic signals picked up by the subwoofer channel speaker. Hence, resonance pressure within the housing 410 is greatly reduced. To produce acoustic signals that are 180° out of phase, one only has to reverse the polarity of the acoustic coil of both the front channel speaker 420 and the rear channel speaker 430 or the polarity of the acoustic coil of the subwoofer channel speaker 440 only.

In conclusion, major advantages of the multi-channel earphone module of this invention includes:

1. The axis of the front channel speaker and the axis of the rear channel speaker are set at an angle relative to the axis of the subwoofer channel speaker to reduce the overlapping or interference of acoustic waves. Hence, the quality of sound emitted from the earphone module is improved.

2. An additional subwoofer sound box is introduced into each earphone unit so that each speaker has its own associated sound box with the housing which also serves as a common sound box. In other words, this invention provides a system with three speakers and four sound boxes to improve sound quality of each earphone unit.

3. The interior wall at the bottom of the front/rear channel sound boxes has a wavy profile for reducing the reflection of acoustic wave, thereby lowering the overlapping or interference between the reflected wave and a normal wave.

4. The front channel speaker and the rear channel speaker as a group and the subwoofer channel speaker inside each earphone unit are driven out of phase with each other to reduce resonance pressure.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A multi-channel earphone module, at least comprising:
a pair of earphone units for covering the ears of a user, each earphone unit having:
a housing;
a front channel speaker inside the housing;
a rear channel speaker inside the housing adjacent to the front channel speaker, wherein the axis of the front channel speaker and the axis of the rear channel speaker form a first acute angle; and
a subwoofer channel speaker inside the housing.

2. The earphone module of claim 1, wherein the module further includes a bridging element linking the earphone units together so that the earphone units can be worn over each respective ear.

3. The earphone module of claim 1, wherein the first acute angle is within the range 25°˜35°.

4. The earphone module of claim 1, wherein the axis of the front channel speaker and the axis of the subwoofer channel speaker form a second acute angle within the range 5°˜15°, and the axis of the rear channel speaker and the axis of the subwoofer channel speaker form a third acute angle within the range 15°˜25°.

5. The earphone module of claim 1, wherein each earphone unit further includes:
a front channel sound box inside the housing for enclosing the front channel speaker;
a rear channel sound box inside the housing for enclosing the rear channel speaker; and
a subwoofer channel sound box at the bottom of the housing for enclosing the subwoofer channel speaker.

6. The earphone module of claim 5, wherein the wall at the bottom of the front channel sound box has a wavy interior surface and at least a venting hole passing through the wall.

7. The earphone module of claim 6, wherein the wave pattern on the wavy interior surface radiates outward and corresponds with the axial direction of the front channel speaker.

8. The earphone module of claim 5, wherein the wall at the bottom of the rear channel sound box has a wavy interior surface and at least a venting hole passing through the wall.

9. The earphone module of claim 8, wherein the wave pattern on the wavy interior surface radiates outward and corresponds with the axial direction of the rear channel speaker.

10. The earphone module of claim 1, wherein the ratio of diameters along the axial direction between the front channel speaker, the rear channel speaker and the subwoofer channel speaker is (30.5): (28.5): (40.5).

11. The earphone module of claim 1, wherein the phase of the acoustic signals picked up by the front channel speaker and the rear channel speaker as a group and the acoustic signals picked up by the subwoofer channel speaker are 180° out of phase.

12. An earphone unit, at least comprising:
a housing;
a front channel speaker inside the housing;
a rear channel speaker inside the housing adjacent to the front channel speaker, wherein the axis of the front channel speaker and the axis of the rear channel speaker form a first acute angle; and
a subwoofer channel speaker at the bottom of the housing.

13. The earphone unit of claim 12, wherein the first acute angle is within the range 25°˜35°.

14. The earphone unit of claim 12, wherein the axis of the front channel speaker and the axis of the subwoofer channel speaker form a second acute angle within the range 5°˜15°, and the axis of the rear channel speaker and the axis of the subwoofer channel speaker form a third acute angle within the range 15°˜25°.

15. The earphone unit of claim 12, wherein each earphone unit further includes:
a front channel sound box inside the housing for enclosing the front channel speaker;
a rear channel sound box inside the housing for enclosing the rear channel speaker; and
a subwoofer channel sound box at the bottom of the housing for enclosing the subwoofer channel speaker.

16. The earphone unit of claim 15, wherein the wall at the bottom of the front channel sound box has a wavy interior surface and at least a venting hole passing through the wall.

17. The earphone unit of claim 16, wherein the wave pattern on the wavy interior surface radiates outward and corresponds with the axial direction of the front channel speaker.

18. The earphone unit of claim 15, wherein the wall at the bottom of the rear channel sound box has a wavy interior surface and at least a venting hole passing through the wall.

19. The earphone unit of claim 18, wherein the wave pattern on the wavy interior surface radiates outward and corresponds with the axial direction of the rear channel speaker.

20. The earphone unit of claim 13, wherein the ratio of diameters along the axial direction between the front channel speaker, the rear channel speaker and the subwoofer channel speaker is (30.5): (28.5): (40.5).

21. The earphone unit of claim 13, wherein the phase of the acoustic signals picked up by the front channel speaker and the rear channel speaker as a group and the acoustic signals picked up by the subwoofer channel speaker are 180° out of phase.

22. An earphone unit, at least comprising:
a housing;
a front channel speaker inside the housing;
a rear channel speaker inside the housing adjacent to the front channel speaker, wherein the axis of the front channel speaker and the axis of the rear channel speaker form a first acute angle;
a subwoofer channel speaker at the bottom of the housing;
a front channel sound box inside the housing for enclosing the front channel speaker;
a rear channel sound box inside the housing for enclosing the rear channel speaker; and
a subwoofer channel sound box at the bottom of the housing for enclosing the subwoofer channel speaker.

23. An earphone unit, at least comprising:
a speaker; and
a sound box for enclosing the speaker, wherein the wall at the bottom of the sound box has a wavy interior surface and at least a venting hole passing through the wall.

24. The earphone unit of claim 22, wherein the wave pattern on the wavy interior surface radiates outward and corresponds with the axial direction of the speaker.

25. An earphone unit, at least comprising:
a housing;
a front channel speaker inside the housing;
a rear channel speaker inside the housing adjacent to the front channel speaker, wherein the axis of the front channel speaker and the axis of the rear channel speaker form a first acute angle; and
a subwoofer channel speaker at the bottom of the housing,
wherein the phase of the acoustic signal picked up by the front channel speaker and the rear channel speaker as a group and the acoustic signal picked up by the subwoofer channel speaker are 180° out of phase.

26. The earphone unit of claim 25, wherein each earphone unit further includes:
a front channel sound box inside the housing for enclosing the front channel speaker;
a rear channel sound box inside the housing for enclosing the rear channel speaker; and
a subwoofer channel sound box at the bottom of the housing for enclosing the subwoofer channel speaker.
